(19) United States
(12) Patent Application Publication
(10) Pub. No.: US 2025/0369822 A1
(43) Pub. Date: Dec. 4, 2025

(54) WATER LEAK DETECTION AND REPAIR

(71) Applicant: Saudi Arabian Oil Company, Dhahran (SA)

(72) Inventors: Mohammad Badruzzaman, Dhahran (SA); Mohammed A. Al-Sahli, Dammam (SA); Turki H. Al-Fouzan, Khobar (SA)

(21) Appl. No.: 18/675,753

(22) Filed: May 28, 2024

(51) Int. Cl. G01M 3/28; F17D 5/02

(52) U.S. Cl. CPC G01M 3/2807; F17D 5/02

(57) ABSTRACT

Disclosed are methods, systems, and computer-readable media to perform operations including: receiving real-time water cycle data in the facility, wherein the data includes water flow of the water cycle; identifying water nodes in the water cycle based on water flow; determining a difference in water balance for each water node; identifying a leak at a particular water node among the water nodes based on the difference in water balance at the particular water node being higher than a predetermined threshold value; and rendering a visualization comprising a representation of the leak at the particular water node on a display device.

### TECHNICAL FIELD

This disclosure relates generally to water leaks/loss detection in an industrial facility.

### BACKGROUND

Water leaks are likely present in aged and deteriorated water piping networks, and may account for more than 25% of the total input volume into the water piping networks. Furthermore, a substantial volume of water is lost from an industrial water process (e.g., cooling, boiler, etc.) due to inefficiency in operations. A plurality of factors contribute to the water leaks and loss, such as the age of water pipelines, water quality (scaling/corrosion) impact, pinholes in treatment equipment, and lack of real-time visibility to take timely corrective actions. The challenges with water leaks/loss detection include: (i) leaks are invisible as they may occur in the subsurface; (ii) water leaks/loss due to faulty operation is determined after it occurs; (iii) testing and Inspection (T&I) are conducted every five to ten years, which delays the identification of leaks; and (iv) water loss in the industrial water process remains unnoticed.

### BRIEF DESCRIPTION OF THE FIGURES

FIG. 1A illustrates a diagram of an example system for detecting water leaks/loss and recommending corrective repair actions, according to some implementations.

FIG. 1B illustrates a visualization of an industrial facility (e.g., a gas plant) including a water piping network.

FIG. 2 illustrates an example process for detecting water leaks, according to some implementations.

FIG. 3 illustrates an example process for detecting water leaks using instrumentation, according to some implementations.

FIG. 4 illustrates an example process for estimating water loss in industrial water consumption devices, according to some implementations.

FIG. 5A illustrates an example water cycle for a cooling system, according to some implementations.

FIG. 5B illustrates an example water cycle for a condensate tank, according to some implementations.

FIG. 6 illustrates an example process for estimating water loss in a water treatment system, according to some implementations.

FIG. 7 illustrates an example process for repair prioritization, according to some implementations.

FIG. 8 illustrates hydrocarbon production operations that include both one or more field operations and one or more computational operations, which exchange information and control exploration for the production of hydrocarbons, according to some implementations.

FIG. 9 is a schematic illustration of an example controller (or control system) that enables an example system to detect water leaks/loss and recommend corrective repair actions, according to some implementations.

### DETAILED DESCRIPTION

This disclosure describes methods and systems for detecting water leaks/loss on a real-time basis, assisting in the identification of root causes of leaks/loss, and recommending corrective repair actions for leaks/loss in an industrial water process. The techniques deploy real-time monitoring of the water mass balance of a water cycle and model water consumption of industrial water consumption devices to identify and quantity leaks and loss in water piping networks of the industrial water process.

The techniques disclose a water leak/loss detection system. The system (i) acquires real-time data from multiple sensors (e.g., flowmeter, pressure sensor) with an operational technology and information technology (OT/IT) interface; (ii) determines water mass balance, water treatment reject, and water consumption by industrial water consumption devices to identify root causes of water leaks/loss, and recommend repair actions to address water leaks/loss; and (iii) outputs locations of water leaks/loss, the severity of leaks/loss, root causes of leaks/loss, and repair actions for leaks/loss to a display device. In some embodiments, the system renders real-time data from multiple sensors on the display device. In some embodiments, the system renders water mass balance, water treatment reject, and water consumption by industrial water consumption devices, determined in real-time, on the display device.

The techniques disclose a method for detecting water leaks/loss. The method includes: (i) calculating water mass imbalance in a water cycle or in one or more of selected sections within the water cycle, (ii) calculating a reject volume of a wastewater stream of a water treatment system within the water cycle, (iii) modeling of industrial water consumption to detect water loss. Water leaks/loss detected by the method, in combination with visual inspection by a plant inspector, can be used to identify the root cause of the leaks/loss and recommend repair actions.

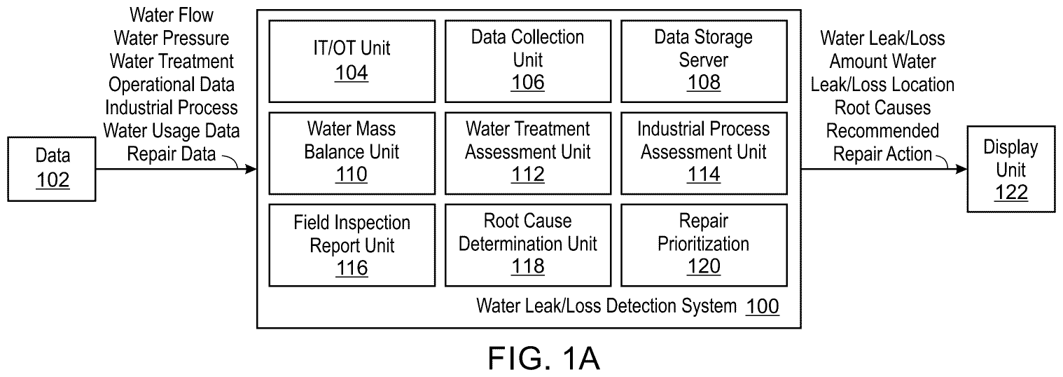

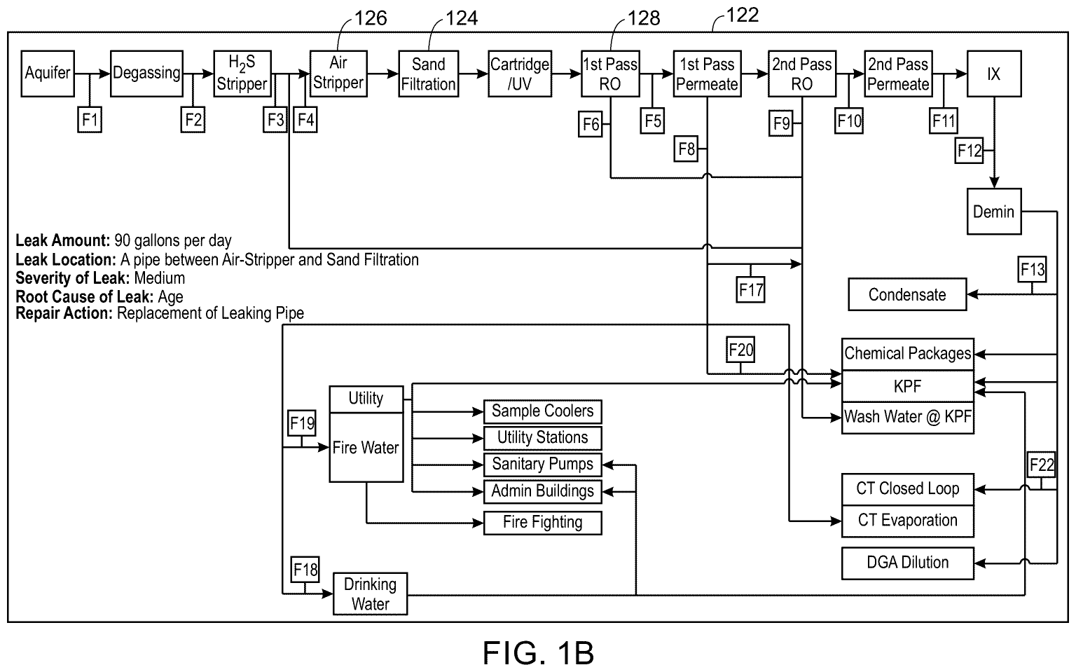

FIG. 1A illustrates a diagram of an example system 100 for detecting water leaks/loss and recommending corrective repair actions, according to some implementations. The system 100 receives data 102 (e.g., water flow, water pressure) from multiple sensors (e.g., flow meter, pressure meter). Data 102 further includes operational data on water treatment, industrial water consumption bills, and repair data from a repair database.

In some implementations, the system 100 includes IT/OT unit 104, data collection unit 106, data storage server 108, water mass balance unit 110, water treatment assessment unit 112, industrial process assessment unit 114, field inspection report unit 116, root cause determination unit 118, and repair recommendation unit 120. The IT/OT unit 104 controls and monitors critical physical equipment and infrastructure in real time. The physical equipment and infrastructure include automation platforms, Supervisory Control and Data Acquisition (SCADA), meters, Laboratory Information Management System (LIMS), Computerized Maintenance Management System (CMMS), etc. Data collection unit 106 includes remote terminal units, meters/sensors, programmable logic controllers, and any advanced metering infrastructure. Data storage server 108 can be a digital internal server (e.g., Excel spreadsheets, Structured Query Language (SQL) or Access servers, SCADA systems and historians, SQL or other proprietary databases, etc.) or a digitalized third-party cloud-based server (e.g., SQL servers, data stored by third parties, etc.). Water mass balance unit 110 determines a mass balance of an entire water cycle or a section of the water cycle. Water treatment assessment unit 112 assesses the performance, reject volume, and important operational parameters. Industrial process assessment unit 114 determines water loss in water cycles of individual water consumption devices (e.g., a cooling system, a boiler system, etc.). Field inspection report unit 116 can keep a log of any visual observations during a field survey and repair activities. Root cause determination unit 118 determines the quantity of water leaks and loss, and identifies the root causes of the leaks/loss. Root causes of leaks/loss in the water piping network include, e.g., damaged pipes, corroded pipes, faulty connections, etc. Repair recommendation unit 120 performs the leaks/loss repair recommendations and prioritization. In some implementations, system 100 can further include a data scrubbing unit (not shown in FIG. 1A) configured to clean data 102 to enhance the data quality.

The system 100 outputs, e.g., water leak/loss amount, leak/loss location, the severity of leak/loss, root causes of leak/loss, and recommended repair actions, to a display unit 122. The display unit 122 renders the outputs on a dashboard. FIG. 1B shows a visualization of an industrial facility (e.g., a gas plant) including a water piping network. F1, F2, F3 . . . F22 represent flow meters. In some embodiments, visualization is rendered on the dashboard by a display device 122. In some embodiments, as shown in FIG. 1B, the water leak/loss amount, leak/loss location, the severity of leak/loss, root causes of leak/loss, and recommended repair actions are rendered on the dashboard in text format. In some embodiments, the water leak/loss amount, leak/loss location, the severity of leak/loss, root causes of leak/loss, and recommended repair actions are rendered on the dashboard in a map format, with information rendered on a map corresponding to the industrial operation. Additionally, in some embodiments, a user selects sections of the water piping network on the dashboard to calculate water mass imbalance in a water cycle.

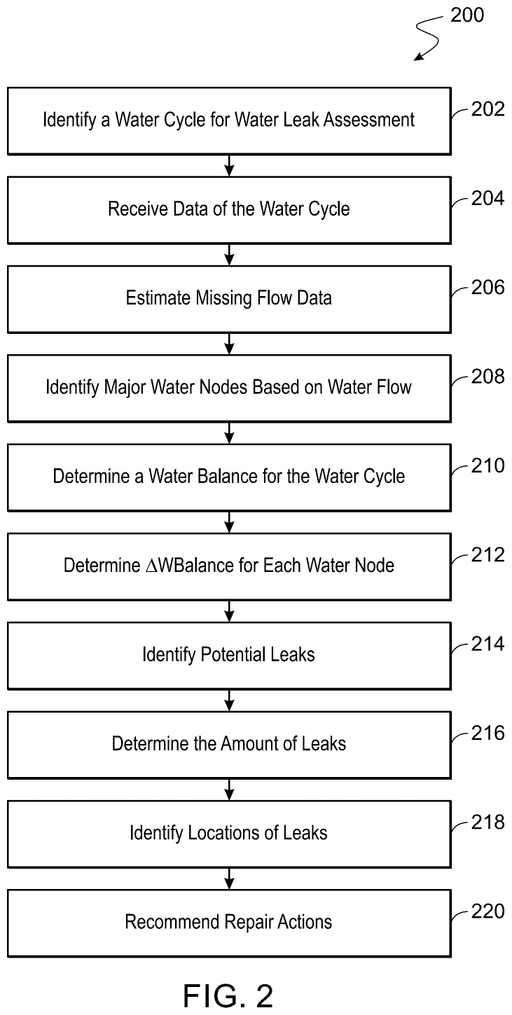

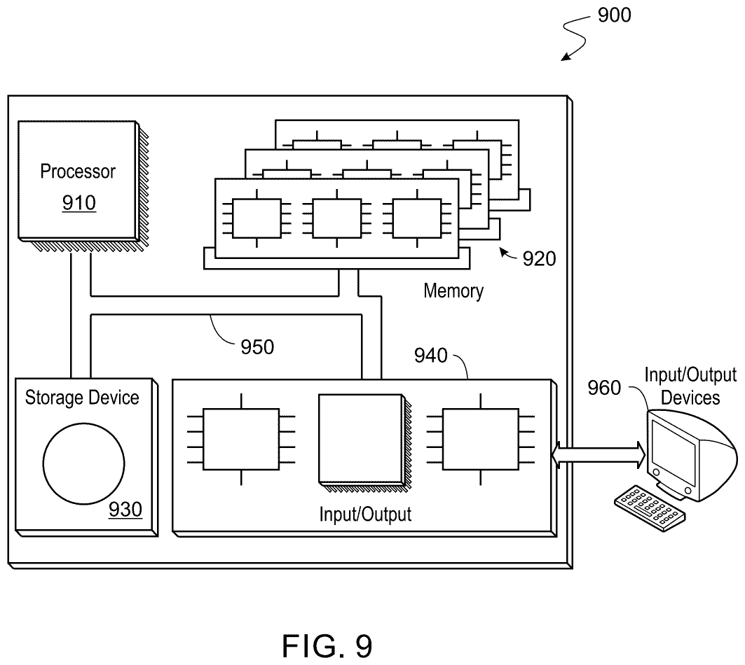

FIG. 2 illustrates an example process for detecting water leaks, according to some implementations. The process 200 is described as being performed by a computing device including one or more processors or a controller, such as controller 900 of FIG. 9. The process 200 may be implemented by system 100 of FIG. 1. The example process 200 shown in FIG. 2 can be modified or reconfigured to include additional, fewer, or different steps (not shown in FIG. 2), which can be performed in the order shown or in a different order.

At 202, the processor or a user identifies a water cycle for water leak assessment. The user (e.g., a facility operator) determines a boundary of water leak assessment. For example, the water leak assessment can be directed to an entire facility or a section of the facility. In some embodiments, a visualization of the facility or a section of the facility is rendered on a dashboard by a display device, and a user selects physical boundaries of the water leak assessment at the dashboard. The user or the processor can identify major water streams (streams with more than 10% water flow of an incoming flow to an industrial facility, e.g., as shown in FIG. 1B) in the boundary. The user or the processor can identify a water cycle based on the major water streams. A complete water cycle includes: (i) water withdrawn from water sources controlled by the facility and treated for industrial uses, (ii) water purchased from a third party (e.g., a public water supply company), and (iii) water supplied to different industrial processes.

At 204, the processor obtains water cycle data that is related to water leak detection. Water cycle data includes, for example, water flow, water pressure, water quality, water treatment operational data, industrial process water consumption bills, and repair data from a repair database. Water cycle data is acquired from flow meters, pressure sensors, the industrial process (water quality data, operational data), and water consumption bills for purchased water. A data scrubbing unit can clean data to enhance the data quality. For example, data cleaning includes removing duplicate data from the water cycle data, removing noises from the water cycle data, or any combinations thereof.

At 206, if flow data is missing, the processor can estimate the flow data. The flow data can be estimated based on the mass balance or pumping records. For example, if the water pump performance characteristics are known, flow data can be estimated as the number of hours that a pump is operated×the average pumping rate.

At 208, the processor identifies major water nodes (water nodes with more than 10% water flow of an incoming flow to an industrial facility, e.g., as shown in FIG. 1B) in the water cycle based on water flow. Major water nodes are points in a water distribution system where significant water flow (more than 10% water flow of an incoming flow) occurs or where water treatment processes take place.

At 210, the processor determines a water balance for the water cycle. The water balance includes the amount of water supplied to and withdrawn from the water cycle. A water balance chart includes types and quantities of: water that is lost through evaporation and drift from the facility (e.g., cooling towers), water consumption for irrigation, and used water discharged from the facility into a sewer system.

At 212, the processor determines a difference in water balance (ΔWBalance) for each water node according to Equation (1), so as to identify potential water leaks between the water nodes.

$$Δ WBalance ( \% ) = \frac{Water In - ( Water Out + Water storage )}{Water In} * 100 \qquad ( 1 )$$

At 214, if the difference in water balance (ΔWBalance) of a water node is higher than a predetermined threshold value, the processor identifies potential leaks at the water node. The threshold value can be determined by a user based on the age of the water piping networks and the leak tolerance of the facility.

At 216, the processor determines the amount of leaks based on Equation (1). The amount of leaks can be ΔWbalance (%)*Water In.

At 218, the processor identifies locations of leaks based on ΔWBalance of each water node. For example, if a water node has ΔWBalance that satisfies the predetermined threshold value, leaks/loss is present in water pipes related to this water node. In some embodiments, the identified locations are rendered on a dashboard by the display device (e.g., display unit 122 of FIG. 1). In some examples, an influent flow towards the sand filtration system 124 (a major node in FIG. 1B) is monitored by measuring a feed flow from air stripper 126 (flow meter F4). An effluent flow from the sand filtration system 124 to the first pass Reverse Osmosis (RO) system 128 can be monitored by measuring a sum of the first pass RO permeate stream (flow meter F5) and first pass RO reject volume (flow meter F6). A water balance ΔWBalance (e.g., 25%) for the sand filtration system 124 is calculated according to Equation (1). ΔWBalance=25% is higher than a predetermined threshold value (e.g., 5%), and the processor identifies potential leaks at the sand filtration system 124. A plant inspector performs an inspection of the sand filtration system 124 and observes that the piping and valves at the sand filtration system 124 are corroded, resulting in pinholes in the piping and blockage, leakage, and passing of valves. It is also observed that one of the sand filters is out of operation for maintenance and is fully corroded, and sand blasts inside. Another sand filter is leaking at the top due to pinholes in the piping.

At 220, the processor generates one or more repair actions for repairing water leaks/loss. In some embodiments, the repair actions are determined by comparing the root cause of leaks/loss, water balance at the leaks/loss, or any combinations thereof with a lookup table including root causes of leaks/loss, water balance at leaks/loss, and associated repair actions. In some embodiments, the one or more repair actions are rendered on the dashboard by the display device. In some embodiments, the one or more repair actions are automatically implemented by the processor.

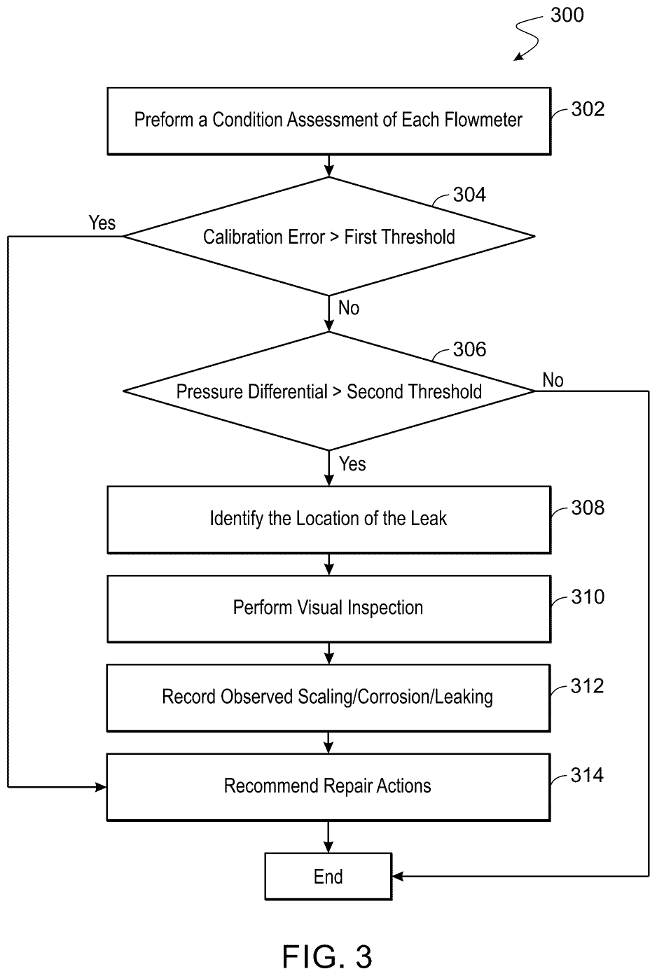

FIG. 3 illustrates an example process for detecting water leaks using instrumentation (e.g., a flowmeter), according to some implementations. The process 300 is described as being performed by a computing device including one or more processors or a controller, such as controller 900 of FIG. 9. The example process 300 shown in FIG. 3 can be modified or reconfigured to include additional, fewer, or different steps (not shown in FIG. 3), which can be performed in the order shown or in a different order.

At 302, the processor performs a condition assessment of each flowmeter to check calibration, faulty operation, and/or lack of connectivity to data collection/storage units. For instance, if a flowmeter is not calibrated on time or an error in calibration is not within the threshold value (or a recommendation value of the manufacturer), the water mass balance estimation based on readings of the flowmeter may be inaccurate.

At 304, the processor determines whether a calibration error of the flowmeter is within a first threshold value (e.g., 3%). If the calibration error is less than the first threshold value, the processor continues to perform 306; if the calibration error is more than the first threshold value, the processor continues to perform 314.

At 306, the processor collects pressure meter readings between nodes/connections. A pressure differential is determined according to Equation (2).

$$Δ PBalance ( \% ) = \frac{Pressure In - Pressure Out}{Pressue In} * 100 \qquad ( 2 )$$

At 308, if the pressure differential exceeds a second threshold value, the processor can identify the location of the leak. The second threshold value is determined by the user. The processor can locate leaks based on the pressure differential.

At 310, a facility operator or inspector performs a visual inspection of valves, sensors, etc., for leak identification, as long-term use of valves and sensors can cause scaling/corrosion/leaking.

At 312, if there are any signs of scaling/corrosion/leaking, the processor records observed scaling/corrosion/leaking.

At 314, the processor recommends a repair plan including repair actions, e.g., (i) calibrating a flow meter, (ii) installing a new flow meter, (iii) repairing a faulty flowmeter, (iv) repairing an aging pipe, (v) installing a pressure meter, (vi) preventing corrosion/scaling by adjusting water chemistry, etc. The repair actions can be recommended and ranked in priority.

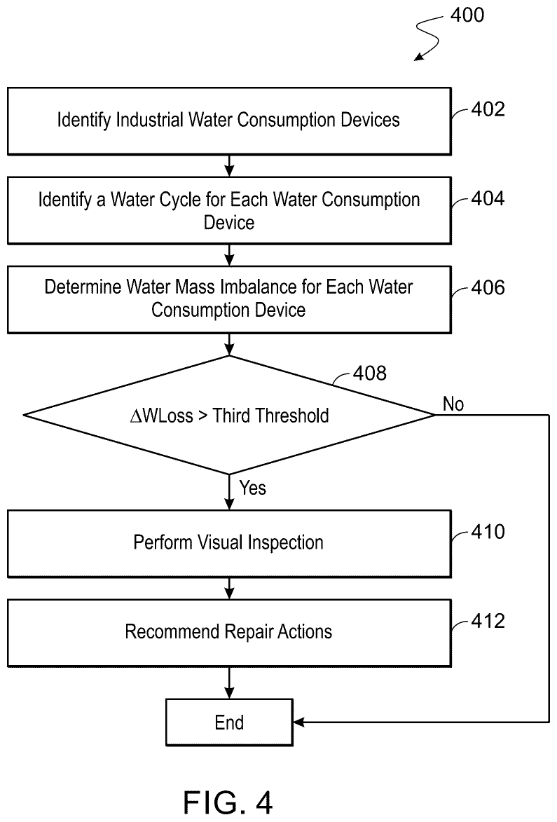

FIG. 4 illustrates an example process for estimating water loss in industrial water consumption devices, according to some implementations. The process 400 is described as being performed by a computing device including one or more processors or a controller, such as controller 900 of FIG. 9. The example process 400 shown in FIG. 4 can be modified or reconfigured to include additional, fewer, or different steps (not shown in FIG. 4), which can be performed in the order shown or in a different order.

At 402, the processor or a user identifies industrial water consumption devices (e.g., a cooling system and boilers) in a facility.

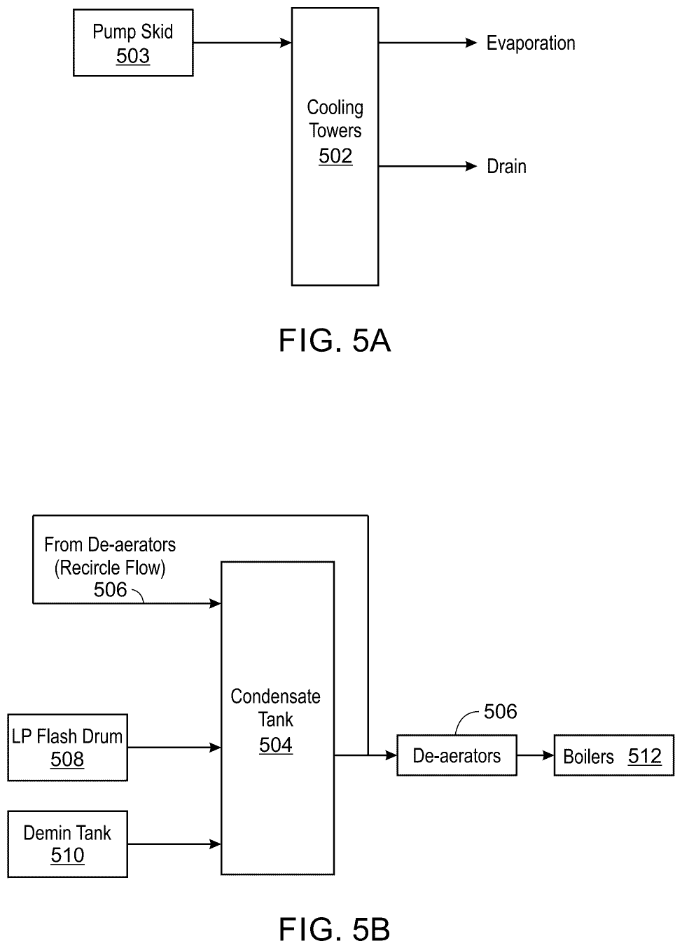

At 404, the processor or a user identifies a water cycle for each water consumption device, so that the processor can calculate a water mass balance of the facility. Example water cycles are shown in FIG. 5. Any water mass imbalance can be used to determine any physical leaks in the water consumption device. When there is water mass imbalance, it indicates that there are discrepancies between the sources of water input and outputs of water.

At 406, the processor can determine water mass imbalance (ΔWLoss) due to inefficient operations based on water consumption modeling (e.g., estimation) for each industrial water consumption device. In some implementations, ΔWLoss due to inefficient operation in the cooling system is calculated according to Equations (3) and (4).

$$Δ WLoss ( \% ) = \frac{{CS}_{Actual} - {CS}_{Modelled}}{{CS}_{Actual}} \qquad ( 3 )$$

$${CS}_{Actual} = Cooling system ( CS ) makeup water during operations$$

$$\begin{matrix}{CS}_{Modelled} = Estimated Cooling system ( CS ) water consumption \\ = {Water}_{evaporation} + {Water}_{blowdown} + {Water}_{drift} \\ = ( ( Flow * heat transfer rate ) + ( \frac{{Water}_{evaporation}}{n - 1} ) + \\ ( 0.0005 \% * flow ) ) * CF\end{matrix} \qquad ( 4 )$$

$$n = Cycle of concentration$$

CF=Correction factor to account for adjustments in estimation based on historical data

In some implementations, the ΔWLoss due to inefficient operation in a boiler system is calculated according to Equations (5) and (6).

$$Δ WLoss ( \% ) = \frac{{BS}_{Actual} - {BS}_{Modelled}}{{BS}_{Actual}} \qquad ( 5 )$$

$${BS}_{Actual} = blowdown stream from Boiler system ( BS ) during operations$$

$${BS}_{Modelled} = Estimated Boiler system ( BS ) water consumption = Max ( \frac{{Feed}_{TDS}}{{Limit}_{TDS}} , \frac{{Feed}_{Silica}}{{Limit}_{Silica}} , \frac{{Feed}_{Chloride}}{{Limit}_{Chloride}} ) * {Feedwater}_{Actual} * CF \qquad ( 6 )$$

Where Feedwater_{Actual}=make-up flow to the boiler system, CF=Correction factor to account for adjustments in estimation based on historical data, where Feedwater_{Actual} is more than BS_{Actual}.

At 408, the processor determines whether ΔWLoss is higher than a predetermined third threshold value. The third threshold value is less than 5% or selected by a user. If the ΔWLoss is higher than the third threshold value, the processor detects a potential water loss.

At 410, A user (e.g., facility operator) performs a visual inspection to detect any leak or overflow in the cooling system and the boiler system (e.g., a steam vent).

At 412, if there are scaling/corrosion/leak signs, the processor recommends a repair plan including repair actions ranked in priority.

FIG. 5A illustrates an example water cycle for a cooling system, according to some implementations. FIG. 5B illustrates an example water cycle for a condensate tank, according to some implementations. A water cycle is a water inflow and a water outflow around a water processing apparatus such as cooling towers 502 and condensate tank 504 as shown in FIGS. 5A and 5B. As shown in FIG. 5A, a water cycle for a cooling system includes water input into one or more cooling towers 502, e.g., water from a pump skid 503; and water output from the one or more cooling towers, e.g., evaporated water and drained water. As shown in FIG. 5B, a water cycle for a condensate tank 504 includes water input into the condensate tank 504, e.g., the water returned from one or more de-aerators 506, water from a low-pressure flash drum 508, water from a demineralization tank 510; and water output from the condensate tank, e.g., water output to one or more de-aerators 506, which are coupled to one or more boilers 512.

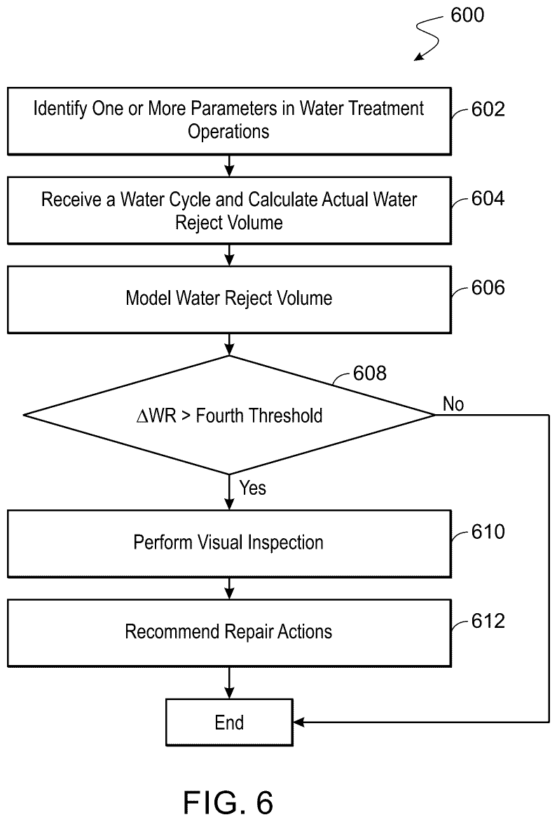

FIG. 6 illustrates an example process for estimating water loss in a water treatment system, according to some implementations. The process 600 is described as being performed by a computing device including one or more processors or a controller, such as controller 900 of FIG. 9. The example process 600 shown in FIG. 6 can be modified or reconfigured to include additional, fewer, or different steps (not shown in FIG. 6), which can be performed in the order shown or in a different order.

At 602, the processor or a user identifies one or more parameters in water treatment operations performed by a water treatment system. The one or more parameters can be used for water loss estimation. For example, the processor identifies a reject volume for water loss estimation for a water treatment system (e.g., a reverse osmosis (RO) and demineralization system).

At 604, the processor receives a water cycle of a water treatment system and calculates the actual water reject volume (e.g., backwash water volume, RO reject volume, demineralization reject volume, etc.).

At 606, the processor models (e.g., estimates) a water reject volume of the water treatment system based on theoretical and historical data. The water reject volume can be provided by a manufacturer of the water treatment system.

At 608, the processor can determine a water reject volume difference ΔWR, which is a difference between actual water reject volume and water reject volume according to Equation (7).

$$Δ WR ( \% ) = \frac{\begin{matrix}Actual Water Reject volume - \\ estimated Water Reject volume\end{matrix}}{Actual Water Reject volume} * 100 \qquad ( 7 )$$

If the ΔWR is above a fourth threshold value, the processor identifies a potential water loss. The fourth threshold value is less than 5% or selected by the user.

At 610, a user (e.g., facility operator) performs a visual inspection to detect scaling/corrosion/leak signs at the connections, valves, etc.

At 612, if there are scaling/corrosion/leak signs at connections or valves, the processor recommends a repair plan including one or more repair actions: (i) adjusting operating parameters, (ii) fixing any malfunction in the water treatment system, (iii) adjusting chemical dosing, (iv) repairing pin holes in the water treatment facility. The one or more repair actions are ranked in priority.

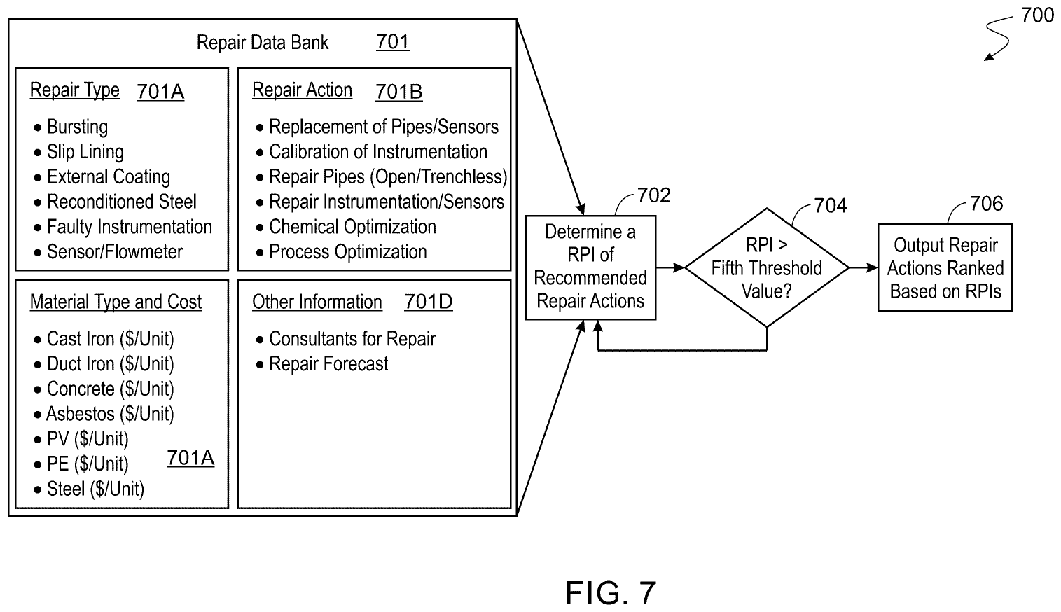

FIG. 7 illustrates an example process for repair prioritization, according to some implementations. The process 700 is described as being performed by a computing device including one or more processors or a controller, such as controller 900 of FIG. 9. The example process 700 shown in FIG. 7 can be modified or reconfigured to include additional, fewer, or different steps (not shown in FIG. 7), which can be performed in the order shown or in a different order.

The example process 700 illustrates the prioritization of repair actions using a repair data bank 701. The recommended repair actions at 220, 314, 412, or 612 can be prioritized according to the example process 700. The repair data bank 701 includes accumulated repair data that deposits from historic repair plans. The repair data bank 701 includes repair types 701A, repair actions 701B, material types and costs for repair actions 701C, and other information 701D, etc.

Example repair types 701A include bursting, slip lining, external coating, reconditioned steel, faulty instrumentation, and sensor/flowmeter. Example repair actions 701B include replacement of pipes/sensors, calibration of instrumentation, repair pipes, repair instrumentation/sensors, chemical optimization, and process optimization. Example material types and costs for repair actions 701C include cast iron, duct iron, concrete, asbestos, PV, PE, and steel. Other information 701D includes consultants for repair and repair forecast.

At 702, the processor determines a Repair Priority Index (RPI) of each recommended repair action according to Equation (8).

$$Repair Priority Index ( RPI ) = ( WS , RC , ETC ) \qquad ( 8 )$$

Where WS (Estimated Water Savings)=Water leak/loss rate (cubic meter/hour)×duration until correction/repair; RC (Estimated Repair Costs) is determined based on a type of repair and associated costs by repair experts; ETC (Estimated Time to Complete Repair) is determined by repair experts.

At 704, the processor determines whether a RPI of each recommended repair action is higher than a fifth threshold value predetermined by a user.

At 706, If the RPI of each recommended repair action is higher than the fifth threshold value, the processor outputs repair actions ranked based on RPIs (the higher RPI, the higher priority) on a display.

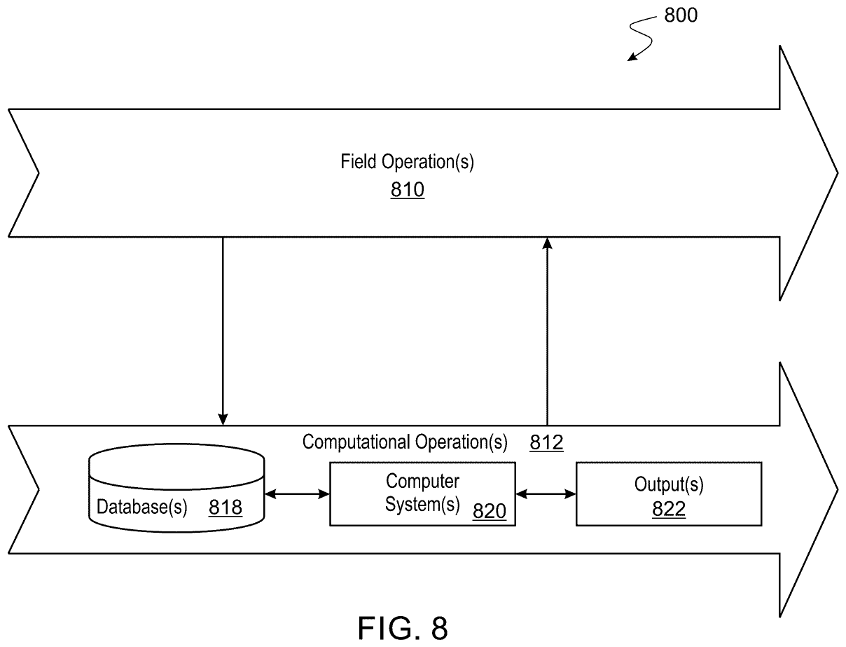

FIG. 8 illustrates hydrocarbon production operations 800 that include both one or more field operations 810 and one or more computational operations 812, which exchange information and control exploration for the production of hydrocarbons. In some implementations, outputs of techniques of the present disclosure can be performed before, during, or in combination with the hydrocarbon production operations 800, specifically, for example, either as field operations 810 or computational operations 812, or both.

Examples of field operations 810 include forming/drilling a wellbore, hydraulic fracturing, producing through the wellbore, and injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively or in addition, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth, and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real time.

The one or more computer systems 820 can update the 3D maps of the subsurface formation as information from one exploration well is received, and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery, and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 9 is a schematic illustration of an example controller 900 (or control system) that enables an example system to detect water leaks/loss and recommend corrective repair actions, according to some implementations. For example, the controller 900 may be operable according to the processes 200, 300, 400, 600, and 700 of FIGS. 2-4 and 6-7. The controller 900 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 900 includes a processor 910, a memory 920, a storage device 930, and an input/output interface 940 communicatively coupled with input/output devices 960 (for example, displays, keyboards, measurement devices, sensors, valves, pumps). Each of the components 910, 920, 930, and 940 are interconnected using a system bus 950. The processor 910 is capable of processing instructions for execution within the controller 900. The processor may be designed using any of a number of architectures. For example, the processor 910 may be a CISC (Complex Instruction Set Computers) processor, a RISC (Reduced Instruction Set Computer) processor, or a MISC (Minimal Instruction Set Computer) processor.

In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output interface 940.

The memory 920 stores information within the controller 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the controller 900. In one implementation, the storage device 930 is a computer-readable medium. In various different implementations, the storage device 930 may be a floppy disk device, a hard disk device, an optical disk device, or a tape device.

The input/output interface 940 provides input/output operations for the controller 900. In one implementation, the input/output devices 960 include a keyboard and/or pointing device. In another implementation, the input/output devices 960 includes a display unit for displaying graphical user interfaces.

There can be any number of controllers 900 associated with, or external to, a computer system containing controller 900, with each controller 900 communicating over a network.

Further, the terms “client,” “user,” and other appropriate terminology can be used interchangeably, as appropriate, without departing from the scope of the present disclosure. Moreover, the present disclosure contemplates that many users can use one controller 900, and one user can use multiple controllers 900.

### Embodiments/Examples

According to some non-limiting embodiments or examples, provided is a computer-implemented method for detecting water leak in a facility, comprising: receiving real-time water cycle data in the facility, wherein the data includes water flow of the water cycle; identifying water nodes in the water cycle based on water flow; determining a difference in water balance for each water node; identifying a leak at a particular water node among the water nodes based on the difference in water balance at the particular water node being higher than a predetermined threshold value; and rendering a visualization comprising a representation of the leak at the particular water node on a display device.

According to some non-limiting embodiments or examples, provided is an apparatus comprising a non-transitory, computer readable, storage medium that stores instructions that, when executed by at least one processor, cause the at least one processor to perform operations comprising: determining a water mass imbalance in a water cycle of a water consumption device; identifying a water loss based on the water mass imbalance being higher than a predetermined threshold value; and rendering a visualization comprising a representation of the water loss on a display device.

According to some non-limiting embodiments or examples, provided is a system, comprising: one or more memory modules; one or more hardware processors communicably coupled to the one or more memory modules, the one or more hardware processors configured to execute instructions stored on the one or more memory modules to perform operations comprising: determining an actual water reject volume in a water cycle of a water treatment system; estimating a water reject volume in the water cycle of the water treatment system; determining a water reject volume difference between the actual water reject volume and the estimated water reject volume; identifying a water loss based on the water reject volume difference being higher than a predetermined threshold value; and rendering a visualization comprising a representation of the water loss on a display device.

Further non-limiting aspects or embodiments are set forth in the following numbered embodiments:

Embodiment 1: A computer-implemented method for detecting water leak in a facility, comprising: receiving real-time water cycle data in the facility, wherein the data includes water flow of the water cycle; identifying water nodes in the water cycle based on water flow; determining a difference in water balance for each water node; identifying a leak at a particular water node among the water nodes based on the difference in water balance at the particular water node being higher than a predetermined threshold value; and rendering a visualization comprising a representation of the leak at the particular water node on a display device.

Embodiment 2: The computer-implemented method of Embodiment 1, further comprising: recommending one or more repair actions for repairing the leak.

Embodiment 3: The computer-implemented method of Embodiment 1 or 2, further comprising: estimating the water flow based on a water mass balance.

Embodiment 4: The computer-implemented method of any one of Embodiments 1-3, further comprising: estimating the water flow based on a pump, wherein the water flow is the number of hours that the pump is operated×an average pumping rate.

Embodiment 5: The computer-implemented method of any one of Embodiments 1-4, wherein an amount of the leak at the particular water node is the same as the difference in water balance of the particular water node.

Embodiment 6: The computer-implemented method of Embodiment 2, recommending the one or more repair actions further comprises: determining a Repair Priority Index (RPI) of each recommended repair action, wherein the RPI is based on estimated water savings, estimated repair costs, and estimated time to complete a respective recommended repair action; and ranking the one or more recommended repair actions based on an RPI of the respective recommended repair action.

Embodiment 7: An apparatus comprising a non-transitory, computer readable, storage medium that stores instructions that, when executed by at least one processor, cause the at least one processor to perform operations comprising: determining a water mass imbalance in a water cycle of a water consumption device; identifying a water loss based on the water mass imbalance being higher than a predetermined threshold value; and rendering a visualization comprising a representation of the water loss on a display device.

Embodiment 8: The apparatus of Embodiment 7, the operations further comprising: receiving a visual inspection result indicating a sign of scaling, corrosion, or leak in the water cycle of the water consumption device; and recommending one or more repair actions to reduce the water loss.

Embodiment 9: The apparatus of Embodiment 7 or 8, wherein recommending the one or more repair actions further comprises: determining a Repair Priority Index (RPI) of each recommended repair action, wherein the RPI is based on estimated water savings, estimated repair costs, and estimated time to complete a respective recommended repair action; and ranking the one or more recommended repair actions based on an RPI of the respective recommended repair action.

Embodiment 10: The apparatus of any one of Embodiments 7-9, wherein the water mass imbalance is a difference between make-up water and estimated water consumption of the water consumption device.

Embodiment 11: The apparatus of Embodiment 10, wherein the estimated water consumption comprises evaporated water, blowdown water, and drift water.

Embodiment 12: The apparatus of Embodiment 10, wherein the water consumption device is a cooling system or a boiler system.

Embodiment 13: A system, comprising: one or more memory modules; one or more hardware processors communicably coupled to the one or more memory modules, the one or more hardware processors configured to execute instructions stored on the one or more memory modules to perform operations comprising: determining an actual water reject volume in a water cycle of a water treatment system; estimating a water reject volume in the water cycle of the water treatment system; determining a water reject volume difference between the actual water reject volume and the estimated water reject volume; identifying a water loss based on the water reject volume difference being higher than a predetermined threshold value; and rendering a visualization comprising a representation of the water loss on a display device.

Embodiment 14: The system of Embodiment 13, wherein the operations further comprising: receiving a visual inspection result indicating a sign of scaling, corrosion, or leak in the water cycle of the water treatment system; and recommending one or more repair actions to reduce the water loss.

Embodiment 15: The system of Embodiment 13 or 14, wherein recommending the one or more repair actions further comprises: determining a Repair Priority Index (RPI) of each recommended repair action, wherein the RPI is based on estimated water savings, estimated repair costs, and estimated time to complete a respective recommended repair action; and ranking the one or more recommended repair actions based on an RPI of the respective recommended repair action.

Embodiment 16: The system of Embodiment 14, wherein the one or more repair actions comprise one or more of: (i) adjusting operating parameters, (ii) fixing any malfunction in the water treatment system, (iii) adjusting chemical dosing, or (iv) repairing pin holes in the water treatment system.

Embodiment 17: The system of any one of Embodiments 13-16, wherein the water reject volume comprises backwash water volume, a reverse osmosis reject volume, and a demineralization reject volume.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

We claim:

1. A computer-implemented method for detecting water leak in a facility, comprising:
receiving real-time water cycle data in the facility, wherein the data includes water flow of the water cycle;
identifying water nodes in the water cycle based on water flow;
determining a difference in water balance for each water node;
identifying a leak at a particular water node among the water nodes based on the difference in water balance at the particular water node being higher than a predetermined threshold value; and
rendering a visualization comprising a representation of the leak at the particular water node on a display device.

2. The computer-implemented method of claim 1, further comprising:
recommending one or more repair actions for repairing the leak.

3. The computer-implemented method of claim 1, further comprising:
estimating the water flow based on a water mass balance.

4. The computer-implemented method of claim 1, further comprising:
estimating the water flow based on a pump, wherein the water flow is the number of hours that the pump is operated×an average pumping rate.

5. The computer-implemented method of claim 1, wherein an amount of the leak at the particular water node is the same as the difference in water balance of the particular water node.

6. The computer-implemented method of claim 2, recommending the one or more repair actions further comprises:
determining a Repair Priority Index (RPI) of each recommended repair action, wherein the RPI is based on estimated water savings, estimated repair costs, and estimated time to complete a respective recommended repair action; and
ranking the one or more recommended repair actions based on an RPI of the respective recommended repair action.

7. An apparatus comprising a non-transitory, computer readable, storage medium that stores instructions that, when executed by at least one processor, cause the at least one processor to perform operations comprising:
determining a water mass imbalance in a water cycle of a water consumption device;
identifying a water loss based on the water mass imbalance being higher than a predetermined threshold value; and
rendering a visualization comprising a representation of the water loss on a display device.

8. The apparatus of claim 7, the operations further comprising:
receiving a visual inspection result indicating a sign of scaling, corrosion, or leak in the water cycle of the water consumption device; and
recommending one or more repair actions to reduce the water loss.

9. The apparatus of claim 8, wherein recommending the one or more repair actions further comprises:
determining a Repair Priority Index (RPI) of each recommended repair action, wherein the RPI is based on estimated water savings, estimated repair costs, and estimated time to complete a respective recommended repair action; and
ranking the one or more recommended repair actions based on an RPI of the respective recommended repair action.

10. The apparatus of claim 7, wherein the water mass imbalance is a difference between make-up water and estimated water consumption of the water consumption device.

11. The apparatus of claim 10, wherein the estimated water consumption comprises evaporated water, blowdown water, and drift water.

12. The apparatus of claim 10, wherein the water consumption device is a cooling system or a boiler system.

13. A system, comprising:
one or more memory modules;
one or more hardware processors communicably coupled to the one or more memory modules, the one or more hardware processors configured to execute instructions stored on the one or more memory modules to perform operations comprising:
determining an actual water reject volume in a water cycle of a water treatment system;
estimating a water reject volume in the water cycle of the water treatment system;
determining a water reject volume difference between the actual water reject volume and the estimated water reject volume;
identifying a water loss based on the water reject volume difference being higher than a predetermined threshold value; and
rendering a visualization comprising a representation of the water loss on a display device.

14. The system of claim 13, wherein the operations further comprising:
receiving a visual inspection result indicating a sign of scaling, corrosion, or leak in the water cycle of the water treatment system; and
recommending one or more repair actions to reduce the water loss.

15. The system of claim 14, wherein recommending the one or more repair actions further comprises:
determining a Repair Priority Index (RPI) of each recommended repair action, wherein the RPI is based on estimated water savings, estimated repair costs, and estimated time to complete a respective recommended repair action; and
ranking the one or more recommended repair actions based on an RPI of the respective recommended repair action.

16. The system of claim 14, wherein the one or more repair actions comprise one or more of:
(i) adjusting operating parameters,
(ii) fixing any malfunction in the water treatment system,
(iii) adjusting chemical dosing, or
(iv) repairing pin holes in the water treatment system.

17. The system of claim 13, wherein the water reject volume comprises backwash water volume, a reverse osmosis reject volume, and a demineralization reject volume.
